(19) United States
(12) Patent Application Publication
(10) Pub. No.: US 2012/0025493 A1
(43) Pub. Date: Feb. 2, 2012

(54) Baby Carriage

(75) Inventors: Zhenghuan Song, Jiangsu (CN); Jie Hu, Jiangsu (CN)

(73) Assignee: GOODBABY CHILD PRODUCTS CO., LTD., Jiangsu (CN)

(21) Appl. No.: 13/060,485

(22) PCT Filed: Dec. 1, 2008
(86) PCT No.: PCT/CN08/73272

§ 371 Date: Oct. 13, 2011

(30) Foreign Application Priority Data
Aug. 29, 2008 (CN) 200820041713.2
Aug. 29, 2008 (CN) 200820041714.7
Aug. 29, 2008 (CN) 200820041715.1

(51) Int. Cl. B62B 7/06

(52) U.S. Cl. 280/647

(57) ABSTRACT

A baby carriage is disclosed. Its carriage frame (1) comprises a first front wheel bracket (11), a first push rod (12) with the lower end rotatablely connected to the upper portion of the first front wheel bracket (11), a first seat rod (13) with the front portion rotatablely connected to the first front wheel bracket (11), a second front wheel bracket (21), a second push rod (22) with the lower end rotatablely connected to the upper portion of the second front wheel bracket (21), a second seat rod (23) with the front portion rotatablely connected to the second front wheel bracket (21), a back supporting frame (40) composed of a first back rod (41) and a second back bottom rod (42) that intersect and rotatablely connect with each other at the intersection joint, and a bottom supporting frame (30) composed of a first bottom rod (31) and a second bottom rod (32) that intersect and rotatablely connect with each other at the intersection joint. The upper end of the first back rod (41) is rotatablely arranged to the first push rod (12), and the upper end of the second back rod (42) is rotatablely arranged to the second push rod (22). The back portion of the first seat rod (13) is rotatablely connected to the second back rod (42), and the back portion of the second seat rod (23) is rotatablely connected to the first back rod (41). The bottom supporting frame (30) is disposed between the two front wheel brackets (11, 21) and the two seat rods (13, 23). The back end of the first bottom rod (31) is rotatablely connected to the back portion of second seat rod (23) through a fourth rotational joint (36), and the back end of the second bottom rod (32) is rotatablely connected to the back portion of the first seat rod (13) through a third rotational joint (35). The back portion of the first seat rod (13) is rotatablely connected to the second back rod (42) through a seventh rotational joint (45), and the back portion of the second seat rod (23) is rotatablely connected to the first back rod (41) through a eighth rotational joint (46). It is noted that the fewer rods of the carriage frame significantly reduce the production cost.

### FIELD OF THE INVENTION

The present invention relates to a baby carriage, more particularly, to a frame-foldable baby carriage.

### DESCRIPTION OF THE RELATED ART

The publication of patent application No. CN99239322.1 disclosed a foldable baby carriage, the carriage frame of which comprises side frames on both sides, and a supporting frame connecting the side frames. Each side frame on either side is composed of a four-bar mechanism composed of a front wheel bracket, a push rod, a seat rod and a back rod. The supporting frame comprises a bottom supporting frame disposed between the two front wheel brackets and the two back rods, and a back supporting frame disposed between the two push rods and the two back rods. It is noted that the numerous rods of the carriage frame greatly increase the production cost.

### SUMMARY OF THE INVENTION

The object of the present invention is to provide a baby carriage of low cost.

In order to obtain one or more of these objects, the invention provides a baby carriage, comprising a carriage frame provided with an unfolded position and a folded position, front wheel assemblies, back wheel assemblies, and a locking mechanism disposed on the carriage frame for locking the carriage frame into the unfolded position, wherein, the carriage frame comprises:
a first front wheel bracket with first front wheel assemblies arranged under the first front wheel bracket;
a first push rod, the lower end of which is rotatablely connected to the upper portion of the first front wheel bracket;
a first seat rod, the front portion of which is rotatablely connected to the first front wheel bracket;
a second front wheel bracket with second front wheel assemblies arranged under the second front wheel bracket;
a second push rod, the lower end of which is rotatablely connected to the upper portion of the second front wheel bracket;
a second seat rod, the front portion of which is rotatablely connected to the second front wheel bracket;
a transversely foldable bottom supporting frame, comprising a first bottom rod and a second bottom rod that intersect and rotatablely connect with each other at the intersection joint, whereby, the front end of the first bottom rod is rotatablely arranged to the first front wheel bracket through a first rotational joint, and the front end of the second bottom rod is rotatablely arranged to the second front wheel bracket through a second rotational joint;
a transversely foldable back supporting frame, comprising a first back rod and a second back rod that intersect and rotatablely connect with each other at the intersection joint, whereby, the upper end of the first back rod is rotatablely arranged to the first push rod through a fifth rotational joint, and the upper end of the second back rod is rotatablely arranged to the second push rod through a sixth rotational joint; wherein,
the back end of the first bottom rod is rotatablely connected to the back portion of second seat rod through a fourth rotational joint, and the back end of the second bottom rod is rotatablely connected to the back portion of the first seat rod through a third rotational joint;
the lower end of the first back rod is rotatablely connected to the back portion of the second seat rod through a eighth rotational joint, and the lower end of the second back rod is rotatablely connected to the back portion of the first seat rod through a seventh rotational joint;
first back wheel assemblies are disposed at either the lower end of the second back rod or the back end of the first seat rod or the back portion of the second bottom rod, and second back wheel assemblies are disposed at either the lower end of the first back rod or the back end of the second seat rod or the back portion of the first bottom rod.

The baby carriage described above can be folded in light of the following process: unlocking the locking mechanism, and then pushing the two push rod forward to actuate the back supporting frame folding transversely with the upper portion leaning forward synchronizely, and the bottom supporting frame folding transversely to finish the folding.

Preferably, the locking mechanism can be disposed on the back supporting frame. Preferably, the locking mechanism is composed of a transversely foldable cross piece disposed between the lower portion of the first back rod and the lower portion of the second back rod.

Preferably, the cross piece comprises a first locking rod with the outer end rotatablely connected to the lower portion of the first back rod, and a second locking rod with the outer end rotatablely connected to the lower portion of the second back rod, wherein, the inner end of the first locking rod is rotatablely connected to the inner end of the second locking rod.

The locking mechanism can also be disposed at the rotary connection joint between the two front wheel brackets and the two push rods. Preferably, the locking mechanism comprises a first locking mechanism disposed at the rotary connection joint between the first front wheel bracket and the first push rod, and a second locking mechanism disposed at the rotary connection joint between the second front wheel bracket and the second push rod.

The first locking mechanism comprises a first locking hook that is rotatablely arranged to the lower portion of the first push rod and is capable of grappling the upper end of the first front wheel bracket, and the second locking mechanism comprises a second locking hook that is rotatablely arranged to the lower portion of the second push rod and is capable of grappling the upper end of the second front wheel bracket.

In a preferred embodiment, the first seat rod extends backwards and downwards from the rotary connection joint with the third rotational joint forming an extension portion of the first seat rod, and the second seat rod extends backwards and downwards from the rotary connection joint with the fourth rotational joint forming an extension portion of the second seat rod, whereby, the first back wheel assemblies are arranged at the extension portion of the first seat rod, and the second back wheel assemblies are arranged at the extension portion of the second seat rod.

In another preferred embodiment, the second back rod extends downwards from the rotary connection joint with the seventh rotational joint forming an extension portion of the second back wheel, and the first back rod extends downwards from the rotary connection joint with the eighth rotational joint forming an extension portion of the first back wheel, whereby, the first back wheel assemblies are arranged at the extension portion of the second back wheel, and the second back wheel assemblies are arranged at the extension portion of first back wheel.

In yet another preferred embodiment, the second bottom rod extends backwards and downwards from the rotary connection joint with the third rotational joint forming an extension portion of the second bottom rod, and the first bottom rod extends backwards and downwards from the rotary connection joint with the fourth rotational joint forming an extension portion of the first bottom rod, whereby, the first back wheel assemblies are arranged at the extension portion of the second bottom rod, and the second back wheel assemblies are arranged at the extension portion of the first bottom rod.

Preferably, the back portion of the first seat rod, the third rotational joint and the seventh rotational joint are rotatablely and coaxially connected, while the back portion of the second seat rod, the fourth rotational joint and the eighth rotational joint are rotatablely and coaxially connected.

The present invention has the advantages that, no additional rods are needed for arranging the two back wheel assemblies whether the first back wheel assemblies and the second back wheel assemblies are disposed on the first seat rod and the second seat rod respectively, or on the second back rod and the first back rod, or on the second bottom rod and the first rod. It is noted that the fewer rods of the carriage frame significantly reduce the production cost.

### BRIEF DESCRIPTION OF THE DRAWINGS

FIG. 1 is a perspective view of the baby carriage of the first preferred embodiment according to the present invention in an unfolded position.

FIG. 2 is a perspective view of the baby carriage of the first preferred embodiment according to the present invention in a semi-folded position.

FIG. 3 is a front view of the baby carriage of the first preferred embodiment according to the present invention in an unfolded position.

FIG. 4 is a front view of the baby carriage of the first preferred embodiment according to the present invention in a semi-folded position.

FIG. 5 is a front view of the baby carriage of the first preferred embodiment according to the present invention in a folded position.

FIG. 6 is a perspective view of the baby carriage of the second preferred embodiment according to the present invention in an unfolded position.

FIG. 7 is a perspective view of the baby carriage of the second preferred embodiment according to the present invention in a semi-folded position.

FIG. 8 is a perspective view of the baby carriage of the third preferred embodiment according to the present invention in an unfolded position.

FIG. 9 is a perspective view of the baby carriage of the fourth preferred embodiment according to the present invention in an unfolded position.

FIG. 10 is a perspective view of the baby carriage of the fifth preferred embodiment according to the present invention in an unfolded position.

FIG. 11 is a perspective view of the baby carriage of the sixth preferred embodiment according to the present invention in an unfolded position.

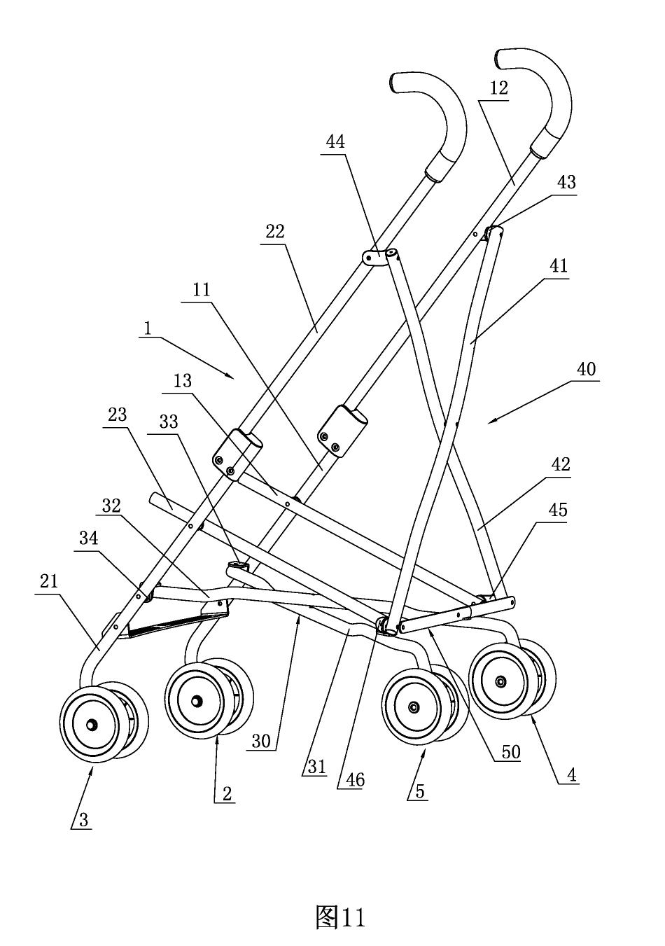

### DETAILED DESCRIPTION OF THE PREFERRED EMBODIMENTS

The detailed descriptions of the preferred embodiments according to the invention are given as below with the accompanying drawings so that the benefits and features of the present invention are understood for those skilled in the art.

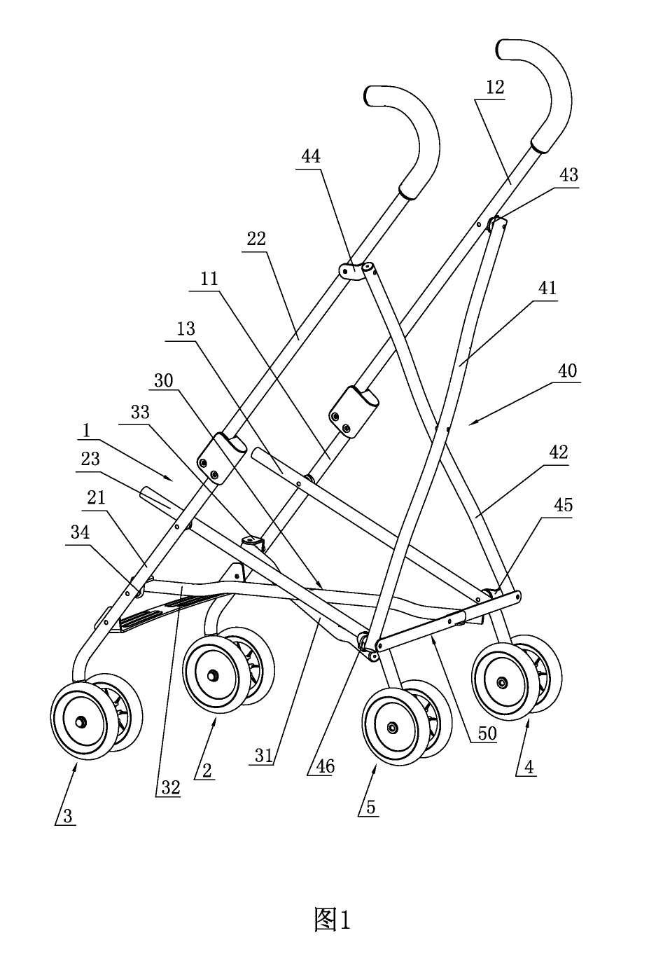

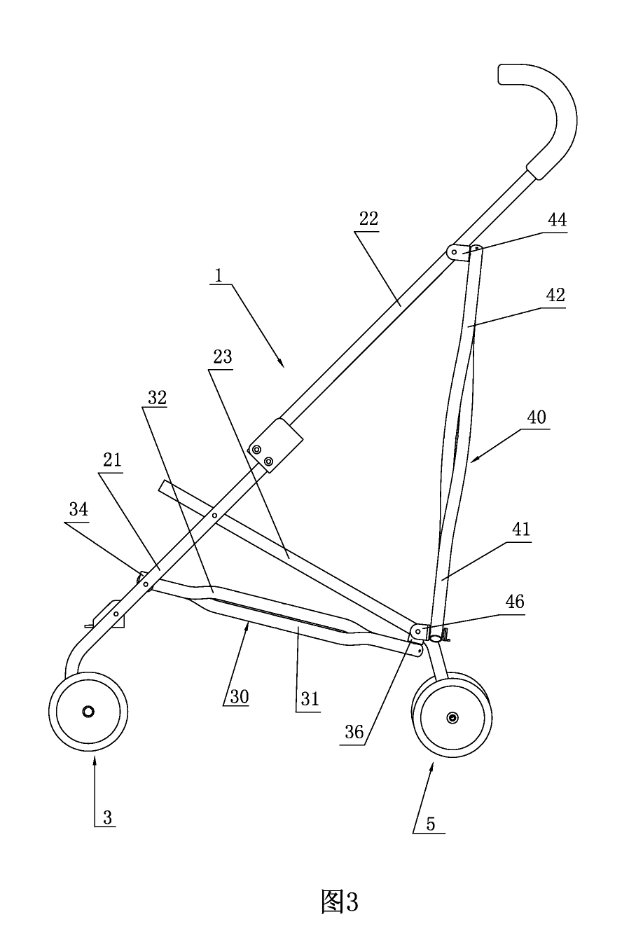

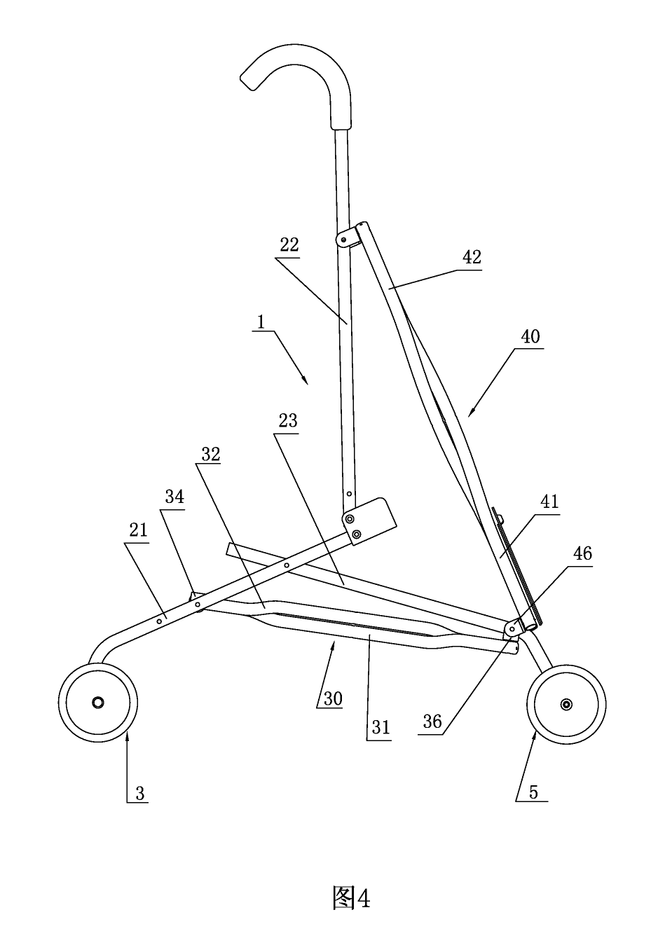

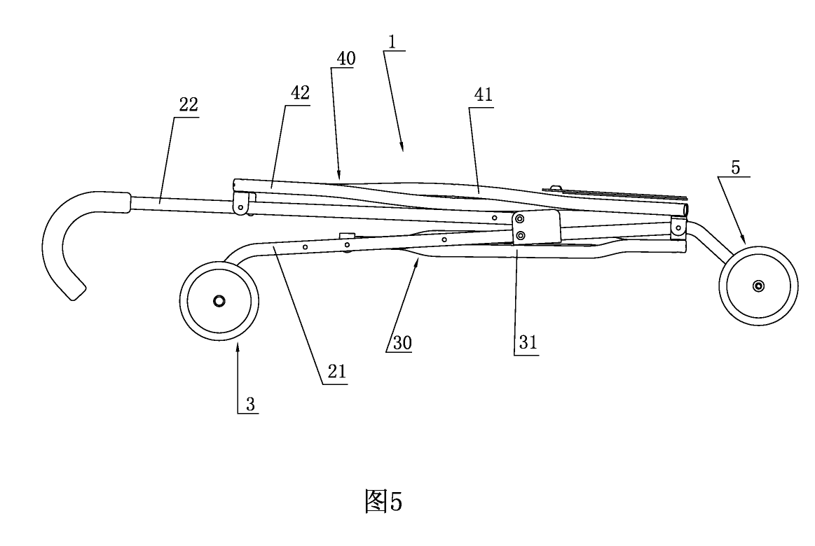

First preferred embodiment: As shown in FIGS. 1 to 5, a baby carriage, comprises a carriage frame 1 provided with an unfolded position and a folded position, front wheel assemblies, back wheel assemblies, a locking mechanism disposed on the carriage frame 1 for locking the carriage frame 1 into the unfolded position, and a cloth cover (not depicted) jacketed on the carriage frame 1.

The carriage frame 1 comprises a first front wheel bracket 11, first front wheel assemblies 2 arranged under the first front wheel bracket 11, a first push rod 12 with the lower end rotatablely connected to the upper portion of the first front wheel bracket 11, a first seat rod 13 with the front portion rotatablely connected to the first front wheel bracket 11, a second front wheel bracket 21, second front wheel assemblies 3 arranged under the second front wheel bracket 21, a second push rod 22 with the lower end rotatablely connected to the upper portion of the second front wheel bracket 21, a second seat rod 23 with the front portion rotatablely connected to the second front wheel bracket 21, a transversely foldable bottom supporting frame 30, and a transversely foldable back supporting frame 40.

The bottom supporting frame 30 comprises a first bottom rod 31 and a second bottom rod 32 that intersect and rotatablely connect with each other at the intersection joint. The front end of the first bottom rod 31 is rotatablely arranged to the first front wheel bracket 11 through a first rotational joint 33, and the front end of the second bottom rod 32 is rotatablely arranged to the second front wheel bracket 21 through a second rotational joint 34. The back supporting frame 40 comprises a first back rod 41 and a second back rod 42 that intersect and rotatablely connect with each other at the intersection joint. The upper end of the first back rod 41 is rotatablely arranged to the first push rod 12 through a fifth rotational joint 43, and the upper end of the second back rod 42 is rotatablely arranged to the second push rod 22 through a sixth rotational joint 44.

The back end of the first bottom rod 31 is rotatablely connected to the back portion of second seat rod 23 through a fourth rotational joint; and the back end of the second bottom rod 32 is rotatablely connected to the back portion of the first seat rod 13 through a third rotational joint 35.

The lower end of the first back rod 41 is rotatablely connected to the back portion of second seat rod 23 through a eighth rotational joint 46; and the lower end of the second back rod 42 is rotatablely connected to the back portion of first seat rod 13 through a seventh rotational joint 45. First back wheel assemblies 4 are disposed at the back portion of the first seat rod 13, and second back wheel assemblies 5 are disposed at the back portion of the second seat rod 23.

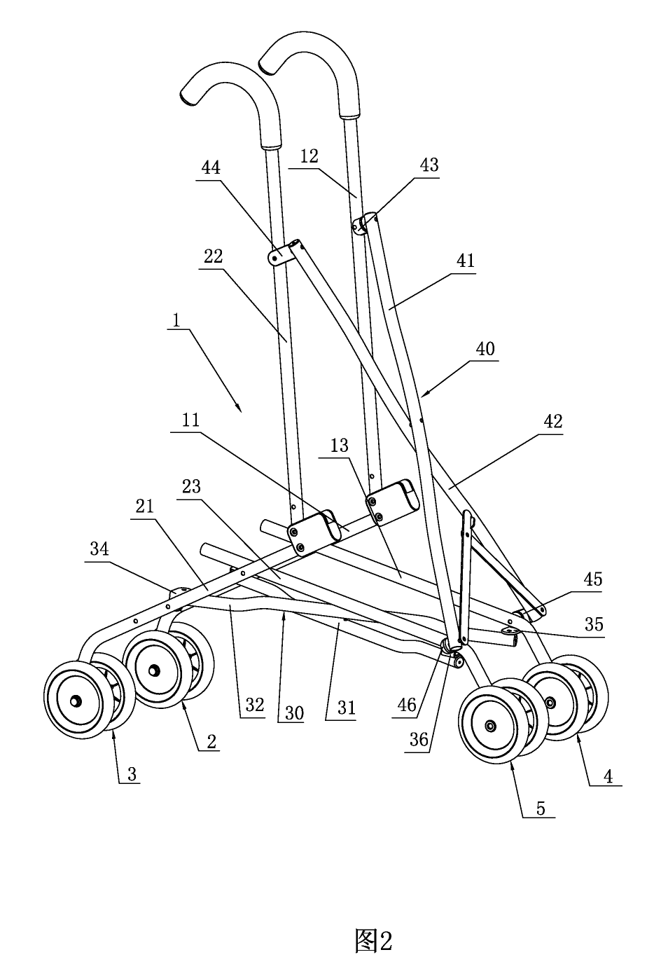

As shown in FIG. 1 and FIG. 2, the locking mechanism is a transversely foldable cross piece 50 which is disposed between the lower portion of the first back rod 41 and the lower portion of the second back rod 42. The cross piece 50 comprises a first locking rod with the outer end rotatablely connected to the lower portion of the first back rod 41, and a second locking rod with the outer end rotatablely connected to the lower portion of the second back rod 42, wherein, the inner end of the first locking rod is rotatablely connected to the inner end of the second locking rod. A locking hook is disposed on the first locking rod which grapples the second locking rod when in the locking position to keep the rods in a line that can not be folded upwards. A limitation mechanism for preventing the rods to fold downwards is disposed between the first locking rod and the second locking rod.

The first seat rod 13 extends backwards and downwards from the rotary connection joint with the third rotational joint 35 forming an extension portion of the first seat rod. The second seat rod 23 extends backwards and downwards from the rotary connection joint with the fourth rotational joint 36 forming an extension portion of the second seat rod. The first back wheel assemblies 4 are arranged at the extension portion of the first seat rod, and the second back wheel assemblies 5 are arranged at the extension portion of the second seat rod.

The back portion of the first seat rod 13, the third rotational joint 35, and the seventh rotational joint 45 are rotatablely and coaxially connected. The back portion of the second seat rod 23, the fourth rotational joint 36, and the eighth rotational joint 46 are rotatablely and coaxially connected.

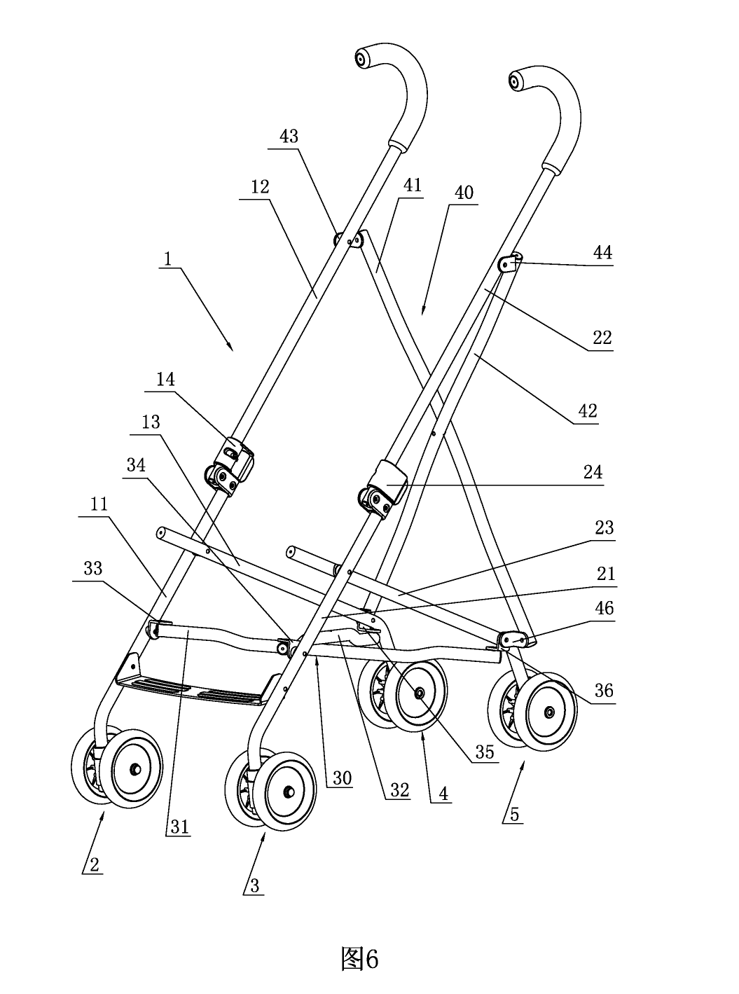

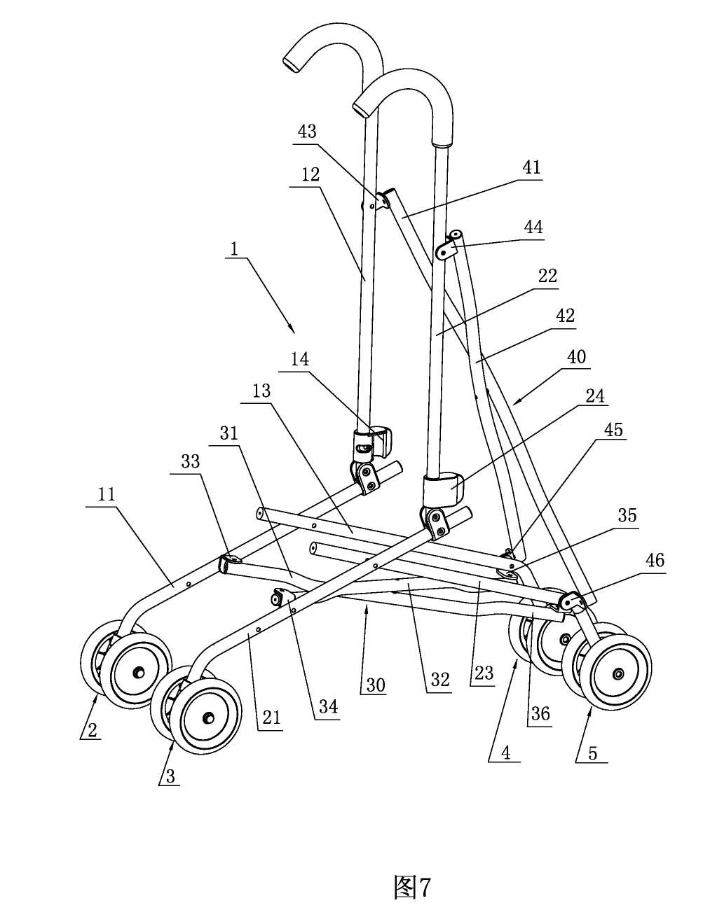

Second preferred embodiment: As shown in FIG. 6 and FIG. 7, the difference from the previous embodiment mainly lies in the locking mechanism, i.e., the locking mechanism of the current embodiment comprises a first locking mechanism disposed at the rotary connection joint between the first front wheel bracket 11 and the first push rod 12, and a second locking mechanism disposed at the rotary connection joint between the second front wheel bracket 21 and the second push rod 22. The first locking mechanism comprises a first locking hook 14 which is rotatablely arranged to the lower portion of the first push rod 12 and is capable of grappling the upper end of the first front wheel bracket 11, and the second locking mechanism comprises a second locking hook 24 which is rotatablely arranged to the lower portion of the second push rod 22 and which is capable of grappling the upper end of the second front wheel bracket 21, whereby, the first locking hook 14 and the second locking hook 24 depart from the first front wheel bracket 11 and the second front wheel bracket 21 respectively by overcoming the elastic resistance thereof to unlock.

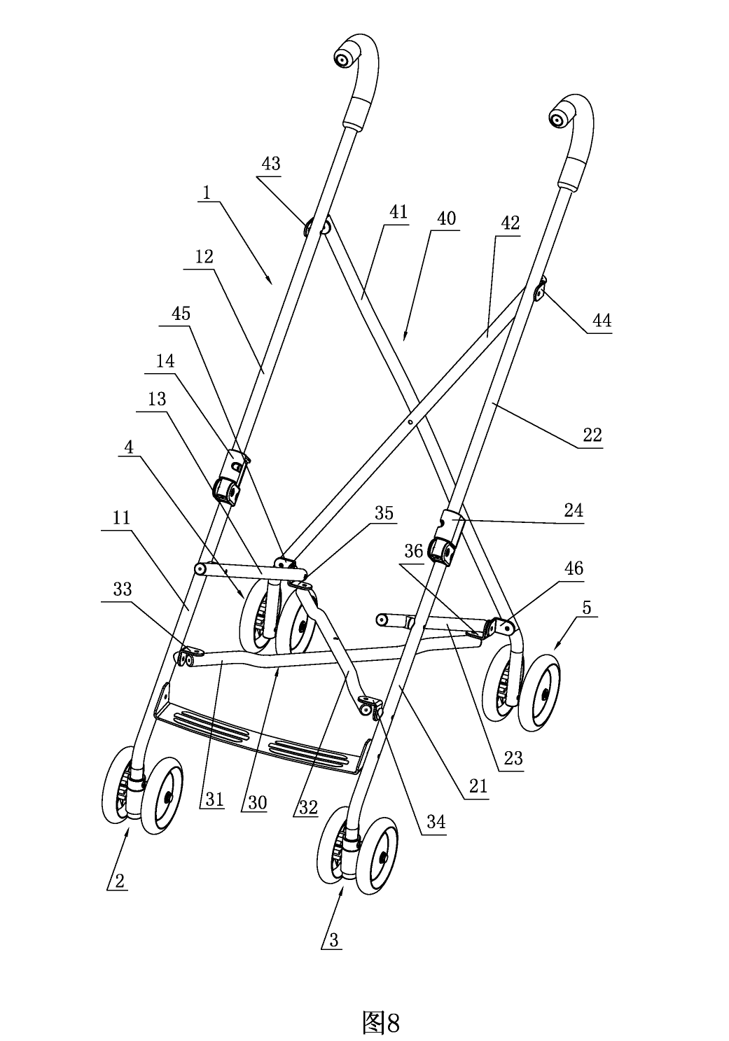

As shown in FIG. 8, the difference of the third embodiment from the first embodiment mainly lies in the arrangement of the first back wheel assemblies 4 and the second back wheel assemblies 5. The first back wheel assemblies 4 are disposed at the lower portion of the second back rod 42, and the second back wheel assemblies 5 are disposed at the lower portion of the first back rod 41, i.e., the second back rod 42 extends downwards from the rotary connection joint with the seventh rotational joint 45 forming an extension portion of the second back wheel, and the first back rod 41 extends downwards from the rotary connection joint with the eighth rotational joint 46 forming an extension portion of the first back wheel, wherein, the first back wheel assemblies 4 are arranged at the extension portion of the first back wheel, and the second back wheel assemblies 5 are arranged at the extension portion of first back wheel.

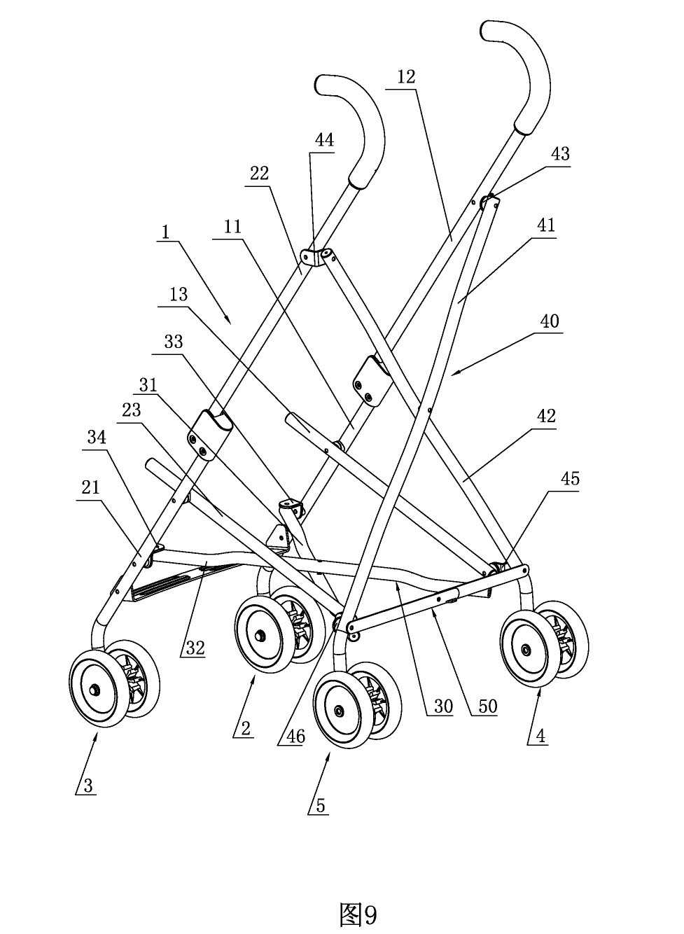

As shown in FIG. 9, the difference of the fourth embodiment from the previous one lies in the locking mechanism provided with the same physical construction as the one in the second embodiment, which is omitted here for abbreviation.

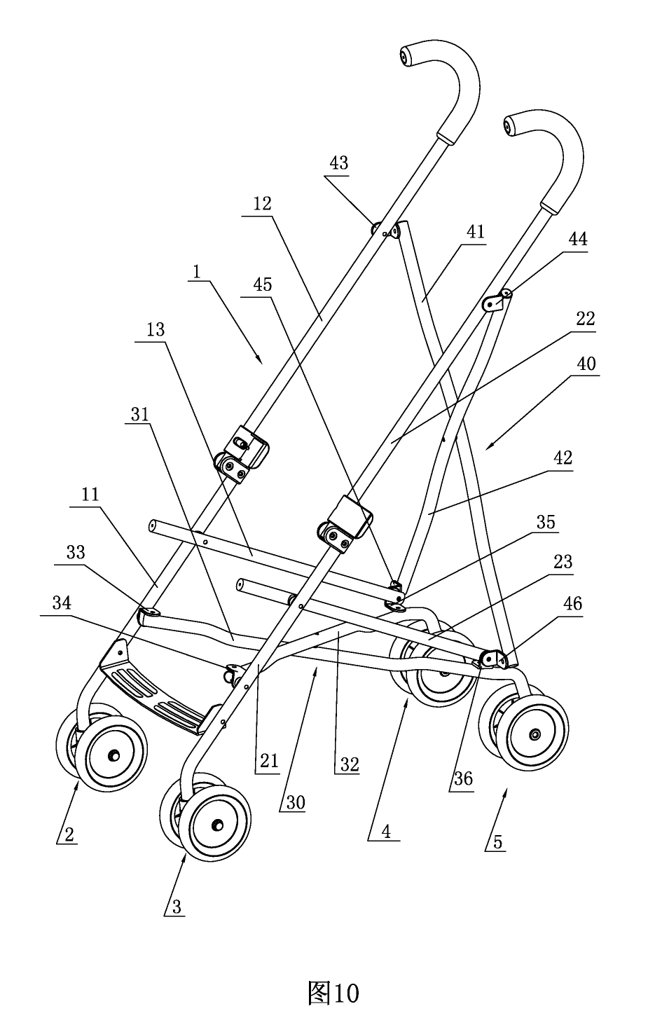

As shown in FIG. 10, the difference of the fifth embodiment from the first embodiment also lies in the arrangement of the first back wheel assemblies 4 and the second back wheel assemblies 5. The second bottom rod 32 extends backwards and downwards from the rotary connection joint with the third rotational joint 35 forming an extension portion of the second bottom rod, and the first bottom rod 31 extends backwards and downwards from the rotary connection joint with the fourth rotational joint 36 forming an extension portion of the first bottom rod, wherein, the first back wheel assemblies are arranged at the extension portion of the second bottom rod, and the second back wheel assemblies are arranged at the extension portion of the first bottom rod. As shown in FIG. 10, the difference of the current embodiment from the previous one lies in the locking mechanism provided with the same physical construction as the one in the second embodiment, which is obvious for those skilled in the art and omitted for abbreviation.

The orientations in the foregoing descriptions, for example “lower”, “upper”, “front”, and “back”, are defined according the carriage frame in the fully unfolded position, wherein, the location where the front wheel assemblies are arranged is defined as “front”, while the location where the back wheel assemblies are arranged is defined as “back”.

The above descriptions are meant to be exemplary only and are not limited to the examples shown in the drawings and described hereinbefore, and those skilled in the art will recognize that changes may be made to the embodiments described without department from the scope of the invention disclosed. Still other modifications varied in efficient manners within the scope of the present invention and their technical equivalents will be apparent to those skilled in the art, in light of a review of this disclosure, and such modifications are intended to fall within the appended claims.

What is claimed is:

1. A baby carriage, comprises a carriage frame (1) provided with an unfolded position and a folded position, front wheel assemblies, back wheel assemblies, and a locking mechanism disposed on the carriage frame (1) for locking the carriage frame (1) into the unfolded position;
the carriage frame (1) comprising:
a first front wheel bracket (11) with first front wheel assemblies (2) arranged under the first front wheel bracket (11);
a first push rod (12), the lower end of which is rotatablely connected to the upper portion of the first front wheel bracket (11);
a first seat rod (13), the front portion of which is rotatablely connected to the first front wheel bracket (11);
a second front wheel bracket (21) with second front wheel assemblies (3) arranged under the second front wheel bracket (21);
a second push rod (22), the lower end of which is rotatablely connected to the upper portion of the second front wheel bracket (21);
a second seat rod (23), the front portion of which is rotatablely connected to the second front wheel bracket (21);
a transversely foldable bottom supporting frame (30), comprising a first bottom rod (31) and a second bottom rod (32) that intersect and rotatablely connect with each other at the intersection joint, whereby, the front end of the first bottom rod (31) is rotatablely arranged to the first front wheel bracket (11) through a first rotational joint (33), and the front end of the second bottom rod (32) is rotatablely arranged to the second front wheel bracket (21) through a second rotational joint (34);
a transversely foldable back supporting frame (40), comprising a first back rod (41) and a second back rod (42) that intersect and rotatablely connect with each other at the intersection joint, whereby, the upper end of the first back rod (41) is rotatablely arranged to the first push rod (12) through a fifth rotational joint (43), and the upper end of the second back rod (42) is rotatablely arranged to the second push rod (22) through a sixth rotational joint (44);
wherein, the back end of the first bottom rod (31) is rotatablely connected to the back portion of second seat rod (23) through a fourth rotational joint (36), and the back end of the second bottom rod (32) is rotatablely connected to the back portion of the first seat rod (13) through a third rotational joint (35); the back portion of the first seat rod (13) is rotatablely connected to the second back rod (42) through a seventh rotational joint (45), and the back portion of the second seat rod (23) is rotatablely connected to the first back rod (41) through a eighth rotational joint (46); first back wheel assemblies (4) are disposed at either the lower end of the second back rod (42) or the back end of the first seat rod (13) or the back portion of the second bottom rod (32), and second back wheel assemblies (5) are disposed at either the lower end of the first back rod (41) or the back end of the second seat rod (23) or the back portion of the first bottom rod (31).

2. The baby carriage as claimed in claim 1, wherein, the locking mechanism comprises a first locking mechanism disposed at the rotary connection joint between the first front wheel bracket (11) and the first push rod (12), and a second locking mechanism disposed at the rotary connection joint between the second front wheel bracket (21) and the second push rod (22).

3. The baby carriage as claimed in claim 2, wherein, the first locking mechanism comprises a first locking hook (14) that is rotatablely arranged to the lower portion of the first push rod (12) and is capable of grappling the upper end of the first front wheel bracket (11), and the second locking mechanism comprises a second locking hook (24) that is rotatablely arranged to the lower portion of the second push rod (22) and is capable of grappling the upper end of the second front wheel bracket (21).

4. The baby carriage as claimed in claim 1, wherein, the locking mechanism is a transversely foldable cross piece (50) disposed between the lower portion of the first back rod (41) and the lower portion of the second back rod (42).

5. The baby carriage as claimed in claim 4, wherein, the cross piece (50) comprises a first locking rod with the outer end rotatablely connected to the lower portion of the first back rod (41), and a second locking rod with the outer end rotatablely connected to the lower portion of the second back rod (42), wherein, the inner end of the first locking rod is rotatablely connected to the inner end of the second locking rod.

6. The baby carriage as claimed in claim 1, wherein, the second back rod (42) extends downwards from the rotary connection joint with the seventh rotational joint (5) forming an extension portion of the second back wheel, and the first back rod (41) extends downwards from the rotary connection joint with the eighth rotational joint (46) forming an extension portion of the first back wheel, whereby, the first back wheel assemblies (4) are arranged at the extension portion of the second back wheel, and the second back wheel assemblies (5) are arranged at the extension portion of first back wheel.

7. The baby carriage as claimed in claim 1, wherein, the second bottom rod (32) extends backwards and downwards from the rotary connection joint with the third rotational joint (35) forming an extension portion of the second bottom rod, and the first bottom rod (31) extends backwards and downwards from the rotary connection joint with the fourth rotational joint (36) forming an extension portion of the first bottom rod, whereby, the first back wheel assemblies (4) are arranged at the extension portion of the second bottom rod, and the second back wheel assemblies (5) are arranged at the extension portion of the first bottom rod.

8. The baby carriage as claimed in claim 1, wherein, the first seat rod (13) extends backwards and downwards from the rotary connection joint with the third rotational joint (35) forming an extension portion of the first seat rod, and the second seat rod (23) extends backwards and downwards from the rotary connection joint with the fourth rotational joint (36) forming an extension portion of the second seat rod, whereby, the first back wheel assemblies (4) are arranged at the extension portion of the first seat rod, and the second back wheel assemblies (5) are arranged at the extension portion of the second seat rod.

9. The baby carriage as claimed in claim 1, wherein, the back portion of the first seat rod (13), the third rotational joint (35) and the seventh rotational joint (45) are rotatablely and coaxially connected, while the back portion of the second seat rod (23), the fourth rotational joint (36), and the eighth rotational joint (46) are rotatablely and coaxially connected.
